(19) United States
(12) Patent Application Publication
(10) Pub. No.: US 2014/0139964 A1
(43) Pub. Date: May 22, 2014

(54) METHOD FOR DRIVING AN ACTUATOR OF A CIRCUIT BREAKER, AND ACTUATOR FOR A CIRCUIT BREAKER

(71) Applicant: ABB Technology AG, Zurich (CH)

(72) Inventors: Christian REUBER, Willich (DE); Günther Mechler, Habmersheim (DE); Ryan Chladny, Muskego, WI (US); Gregor Stengel, Karlsruhe (DE); Jeroen Derkx, Enkoping (SE)

(73) Assignee: ABB Technology AG, Zurich (CH)

(21) Appl. No.: 14/162,930

(22) Filed: Jan. 24, 2014

Related U.S. Application Data
(63) Continuation of application No. PCT/EP2010/063597, filed on Jul. 11, 2012.

(30) Foreign Application Priority Data
Jul. 25, 2011 (EP) 11006096.9

(51) Int. Cl. H01H 47/22; H01H 51/22

(52) U.S. Cl. CPC H01H 47/22; H01H 51/22
USPC 361/115

(57) ABSTRACT

A method and system for driving an actuator of a circuit breaker are disclosed. The method includes supplying a coil of the actuator with a first voltage, wherein the coil can generate a magnetic field, which can cause an armature to move relative to a stator of the actuator from a closed position to an opened position. A second voltage of reverse polarity can be supplied to the coil with respect to the first voltage while the armature is moving relative to the stator, such that the coil can generate a reverse magnetic field, which decelerates the relative movement of the stator and the armature.

RELATED APPLICATION(S)

This application claims priority as a continuation application under 35 U.S.C. §120 to PCT/EP2012/063597, which was filed as an International Application on Jul. 11, 2012, designating the U.S., and which claims priority to European Application No. 11006096.9 filed on Jul. 25, 2011. The entire content of these applications are hereby incorporated by reference in their entireties.

### FIELD

The disclosure relates to the field of high power circuit breakers. For example, the disclosure relates to a method for driving a terminal of a circuit breaker, and to an actuator for the operation of a circuit breaker.

### BACKGROUND INFORMATION

An automatic circuit breaker can include a switching chamber in which two terminals are connected or disconnected for opening and closing an electric path between the two terminals, and an actuator which can be used for generating a relative movement of the two terminals.

For example, an actuator for generating a linear movement can include an armature and a stator that are adapted to move relative to each other and a coil in which a magnetic field may be induced that causes the movement of the stator and the armature from a closed into an opened position or from an open to a closed position.

The armature can be accelerated relative to the stator of the actuator, if it has to be moved from the closed position into the opened position. The movement stops, when the armature hits mechanical components of the stator that limit its movement in the open position. Due to the stopping of the moving components of the actuator, the components of the actuator can be subjected to mechanical stress. Additionally, once the armature reaches the final position relative to the stator, it may have a high kinetic energy and the collision with the stationary structure may cause a mechanical bouncing according to the structural properties of the frame of the device.

This bouncing effect may generate an over-travel and/or a back-travel of the actuator components, for example, the stator and the armature, as well as of the moving terminal of the circuit breaker, which can degrade the switching properties of the circuit breaker.

### SUMMARY

A method for driving an actuator of a circuit breaker is disclosed, the method comprising: supplying a coil of the actuator with a first voltage, the coil configured to generate a magnetic field which causes an armature to move relative to a stator of the actuator from a closed position to an opened position; and supplying the coil with a second voltage of reverse polarity with respect to the first voltage, while the armature is moving relative to the stator, and wherein the coil is configured to generate a reverse magnetic field, which decelerates the relative movement of the stator and the armature.

An actuator for a circuit breaker is disclosed, the actuator comprising: a stator and an armature, which are configured to be movable with respect to each other between a closed position and an opened position; a coil configured to generate a magnetic field, which is adapted to cause a relative movement of the stator and the armature; and a switch circuit configured to connect to a voltage source for supplying the coil with a voltage, and wherein the switch circuit is configured to supply a first voltage, a second voltage, and a third voltage to the coil, wherein the second voltage has a reverse polarity with respect to the first and the third voltages.

A circuit breaker is disclosed, the circuit breaker comprising: an actuator, the actuator, which includes: a stator and an armature, which are configured to be movable with respect to each other between a closed position and an opened position; a coil configured to generate a magnetic field, which is configured to cause a relative movement of the stator and the armature; and a switch circuit configured to connect to a voltage source for supplying the coil with a voltage, wherein the switch circuit is configured to supply a first voltage, a second voltage, and a third voltage to the coil, the second voltage having a reverse polarity with respect to the first and the third voltages; and a switching chamber with a first terminal and a second terminal, wherein the actuator is mechanically connected to the first terminal of the switching chamber, such that the actuator is operable to move the first terminal between a closed position, in which the first terminal is electrically connected with the second terminal, and an opened position, in which the first terminal is electrically disconnected from the second terminal.

### BRIEF DESCRIPTION OF THE DRAWINGS

The disclosure is explained below with reference to the exemplary embodiments, shown in the drawings. In the drawings:

FIG. 1 schematically shows a circuit breaker according to an exemplary embodiment of the disclosure;

FIG. 2 shows an actuator disclosure in a closed position according to an exemplary embodiment of the disclosure;

FIG. 3 shows the actuator of FIG. 2 in an opened position according to an exemplary embodiment of the disclosure;

FIG. 4 shows a switch circuit according to an exemplary embodiment of the disclosure;

FIG. 5A shows the relative position of the stator and the armature during a switching operation of the actuator according to an exemplary embodiment of the disclosure;

FIG. 5B shows the relative velocity of the stator and the armature during a switching operation of an actuator according to an exemplary embodiment of the disclosure;

FIG. 5C shows a voltage signal to be supplied to a coil of an actuator according to an exemplary embodiment of the disclosure; and

FIG. 5D shows the coil current in the coil of an actuator according to an exemplary embodiment of the disclosure.

### DETAILED DESCRIPTION

The reference symbols used in the drawings, and their meanings, are listed in summary form in the list of reference symbols. In principle, identical parts are provided with the same reference symbols in the figures.

In accordance with an exemplary embodiment, a circuit breaker with switching properties is disclosed.

In accordance with an exemplary embodiment, a method for driving the terminals of a circuit breaker relative to each other is disclosed, thus providing an actuator of a circuit breaker. For example, the circuit breaker can be a medium voltage circuit breaker, wherein, for example, a medium voltage can be a voltage between 1 kV and 50 kV.

In accordance with an exemplary embodiment, a method is disclosed, which can include the steps of: supplying a coil of the actuator with a first voltage, such that the coil can generate a magnetic field which directly or indirectly can cause an armature of the actuator starting to move relative to a stator of the actuator from a closed position of the actuator to an opened position of the actuator. The method can further include the step of: supplying the coil with a second voltage of reverse polarity with respect to the first voltage, while the armature is moving relative to the stator, such that the coil can generate a reverse magnetic field, which can decelerate the movement of the armature relative to the stator.

In accordance with an exemplary embodiment, during the opening process of the actuator, the polarity of the DC power supply, for example, the first voltage, can be reversed to achieve a deceleration effect before the impact of the armature onto the stator in the opened position. Since the armature may be decelerated with respect to the stator, the armature can have a lower kinetic energy compared to the situation when the armature is not decelerated, such that, the energy which can be absorbed by the other components of the actuator and/or the circuit breaker may be reduced. For example, due to this, the bouncing effect may be reduced, for example, such that a defined over-travel and back-travel value of the actuator can be reached.

In accordance with an exemplary embodiment, in order to limit the deceleration of the armature in a way that the armature will not stop its movement before it arrives at the closed position, the second voltage may be switched off after a certain time period or a third voltage may be applied for a third time period and then the voltage may be switched off.

In accordance with an exemplary embodiment, the coil may move the armature relative to the stator, for example, the coil can induce a magnetic field in the stator and/or the armature, which counteracts a further magnetic field, for example generated by a permanent magnet, thus causing a force which separates the stator from the armature.

In accordance with an exemplary embodiment, the actuator can include a permanent magnet that can generate a magnetic field which generates a force that pulls the armature in the closed position, and a spring that produces a counterforce to the magnetic force. The spring and the permanent magnet can be chosen such that the magnetic force is bigger than the spring force, if the actuator shall be held in the closed position. With such a setup, for example, the coil can generate a magnetic field that counteracts the magnetic field of the permanent magnet and such reduces the overall magnetic field in a way that the magnetic force is smaller than the spring force. Altogether, this can lead to an overall force causing the armature moving away from a closed position. For example, in this situation, the magnetic field of the coil may indirectly cause the movement of the armature relative to the stator.

According to an exemplary embodiment of the disclosure, the first voltage can be applied during a first time period and the second voltage can be applied during a second time period. Such voltages may be produced with a circuit that can be used to connect the coil with a constant DC voltage source.

According to an exemplary embodiment of the disclosure, the second voltage can have the negative polarity of the first voltage. In this case, the circuit may be constructed very simply, since the coil only has to be connected in a first direction to the voltage source to supply the first voltage and in the opposite direction to supply the second voltage.

According to an exemplary embodiment of the disclosure, the second voltage may be switched off after a certain time period or a third voltage with same polarity as the first voltage may be applied for a certain time period in order to limit the deceleration.

According to an exemplary embodiment of the disclosure, the first voltage can be supplied to the coil during a first time period after which the second voltage can be supplied to the coil for a second time period. After the second time period, the second voltage may be switched off, for example, set to 0 or a third voltage may be applied with same polarity as the first voltage. In accordance with an exemplary embodiment, the switching of the voltage to the third voltage or 0 may be before the stator and the armature reach the opened position of the actuator. With the first time period, the length of the acceleration period of the movement may be set. Further, with the second time period, the length of the deceleration period of the movement may be set. For example, the first time period and the second time period may be chosen such that the movement of the stator and the armature with respect to each other can be optimized with respect to specific objects.

According to an exemplary embodiment of the disclosure, the first voltage, the second voltage, the first time period and the second time period can be optimized, such that a movement speed of the armature approaches zero, when the armature is approaching the opened position. In this case, the kinetic energy of the armature can approach zero, when both components approach the opened position. In such a way, there may be nearly no mechanical stress on the components of the actuator and/or nearly no bouncing effect.

According to an exemplary embodiment of the disclosure the first voltage, the second voltage, the first time period and the second time period can be optimized such that a movement time during which the stator and the armature are moving can be minimized. In accordance with an exemplary embodiment, this optimization can be done under the condition that the movement speed of the armature when arriving at the opened position is not bigger than a predefined value. For example, in this situation, there may be a small bouncing effect, but the circuit breaker may switch faster as in a situation when there is nearly no bouncing effect.

In accordance with an exemplary embodiment, for reliability reasons another condition might be that the speed of the armature when approaching the open position is not smaller than a predefined value in order to help prevent the situation that unexpected friction forces stop the movement before the open position is reached.

However, for example, the above-mentioned time periods can be optimized in such a way, that the movement speed just before reaching the opened position can be adjusted to a defined value and the movement time can be minimized concurrently.

In accordance with an exemplary embodiment, the first voltage and the second voltage can be functions over time, of a DC voltage source, while the values of the second function have the opposite sign of the first function, and that with these voltage functions, the first time period and the second time period can be optimized in the above-mentioned ways.

For example, if the DC voltage source is a loaded capacitor, the absolute value of the voltage function will reduce over time.

In accordance with an exemplary embodiment, the voltages applied to the coil may be pulse with modulated.

In accordance with an exemplary embodiment, an actuator for a circuit breaker is disclosed. According to an exemplary embodiment of the disclosure, the actuator can include a stator and an armature, which can be movable with respect to each other between a closed position and an opened position, a coil for generating a magnetic field which causes a relative movement of the stator and the armature, a switch circuit connected to a voltage source for supplying the coil with a voltage, wherein the switch circuit can be adapted for supplying a first voltage and a second voltage to the coil, wherein the second voltage can have a reverse polarity with respect to the first voltage. With such an actuator, the method as described in the above and in the following can be executed.

For example, the actuator can include a controller, which can be adapted to execute the method as described in the above and in the following. For example, the switch circuit can include switches, for example, semiconductor switches, that can be adapted to connect the coil to the voltage source in two directions. After the controller has received a switch signal, the controller may open the switches of the switch circuit in such a way, that during a first time period, the coil can be connected to the voltage source in a first direction. When the first time period has elapsed, the controller may switch the switches of the switch circuit, such that the coil can be connected to the voltage source in the other direction, such that the reverse voltage can be supplied to the coil. At the end of the second time period, the controller may switch the switches of the switch circuit in such a way, that the coil can be disconnected from the voltage source, such that no voltage is supplied to the coil. In accordance with an exemplary embodiment, the controller can execute the method as described in the above and the following and an actuator with such a controller may be adapted to perform such a method.

In accordance with an exemplary embodiment, the actuator may be constructed, such that the coil can directly cause the movement of the armature relative to the stator. In accordance with an exemplary embodiment, the coil can cause the movement in an indirect way as explained above.

According to an exemplary embodiment of the disclosure, the actuator can include a permanent magnet for generating a force in a closing direction of armature relative to the stator. For example, the permanent magnet may be a part of the stator and the armature may include a ferromagnetic material that can be attracted by the magnetic field that can be induced by the permanent magnet in the material of the stator.

According to an exemplary embodiment of the disclosure, the actuator can include a spring element for generating a force in an opening direction opposite to the closing direction. In accordance with an exemplary embodiment, the force generated by the spring element may counteract the force caused by the permanent magnet. The permanent magnet and the spring element can be chosen, such that the actuator has two stable positions, for example, the opened position and the closed position.

In accordance with an exemplary embodiment, to achieve this, the force of the permanent magnet may be bigger than the force of the spring in the closed position. Starting from closed position the magnetic force between the stator and the armature may decrease when the two components of the actuator can be moved away from each other and the spring element may be a helical spring that has a nearly linearly changing force when being compressed or extended.

In the open position, the spring force in open direction can be small or zero. The armature can be mainly held in open position by magnetic forces on a part of the armature that are caused by the permanent magnet.

According to an exemplary embodiment of the disclosure, an open operation can be started if the coil can cause a magnetic field that reduces the magnetic field caused by the permanent magnet. For example, the magnetic force on the armature can be reduced, such that it becomes smaller than the opening force of the spring element. In accordance with an exemplary embodiment, the coil can be located in the actuator, for example, such that the winding can be excited with current in a direction, such that the magnetic field of the coil caused by the first voltage counteracts the magnetic field of the permanent magnet. For example, the coil may be wound around a yoke of the stator, such that it can generate a magnetic field in the opposite direction as the permanent magnet.

In accordance with an exemplary embodiment, a circuit breaker is disclosed. According to an exemplary embodiment of the disclosure, the circuit breaker can include an actuator as described in the above and the following, and a switching chamber with a first terminal and a second terminal, wherein the actuator can be mechanically connected to the first terminal of the switching chamber, such that the actuator can be adapted to move the first terminal between a closed position, in which the first terminal can be electrically connected with the second terminal, and an opened position in which the first terminal can be electrically disconnected from the second terminal. For example, the first terminal of the switching chamber can be movable with respect to the switching chamber, which may be a vacuum interrupter, and the second terminal can be fixed with respect to the switching chamber. Since such a circuit breaker can have an actuator with a defined moving behaviour and with defined over-travel and back-travel, such a circuit breaker may have a defined switching behaviour, and for example a defined switching time.

In accordance with an exemplary embodiment, the closed and opened position of the switching chamber of the circuit breaker may be reached, when the actuator reaches its closed position and opened position, respectively. However, the switching chamber can reach its closed position, when the actuator is in its opened position and vice versa. For example, the above-mentioned method may be used for either opening the circuit breaker but also for closing the circuit breaker.

According to an exemplary embodiment of the disclosure, a coil that can move an armature relative to a stator of an actuator, can be supplied by a defined coil voltage signal. The current in the coil may be measured by an observing apparatus that may determine from the shape of the current signal the position of the armature relative to the stator as a function of time (position signal).

According to an exemplary embodiment of the disclosure, a coil that can move an armature relative to a stator of an actuator, can be supplied by a defined coil current signal. The voltage between the terminals of the coil may be measured by an observing apparatus that may determine from the shape of the voltage signal the position of the armature relative to the stator as a function of time (position signal).

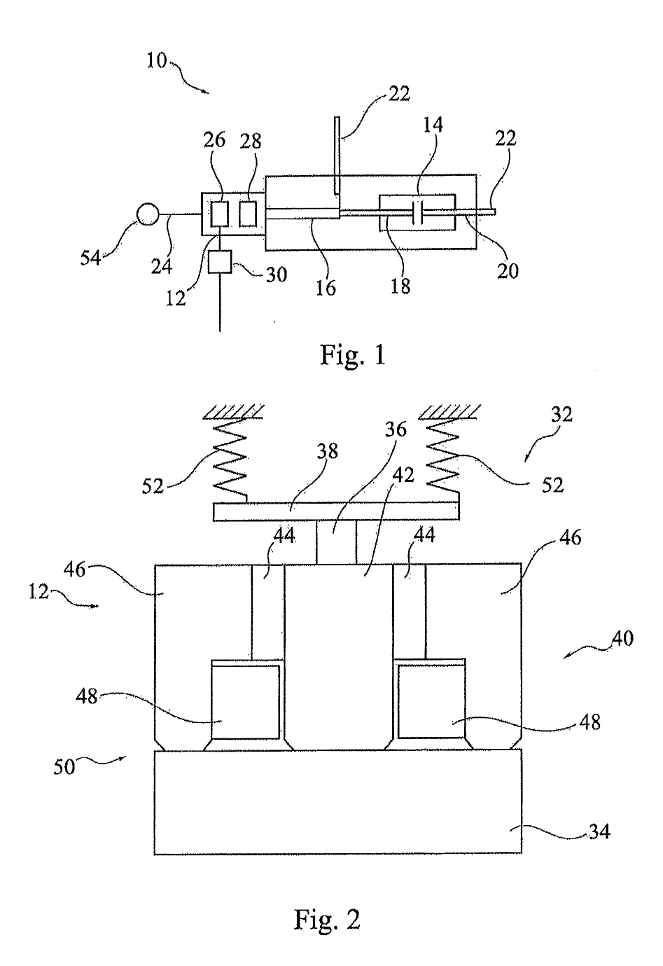

FIG. 1 schematically shows a circuit breaker 10, which includes an actuator 12 and a switching chamber 14. The circuit breaker 10 may be any switching device for example any medium voltage switching device. The actuator 12 can be adapted to generate a linear movement of a rod 16 that can be mechanically connected to a first terminal 18 of the switching chamber 14, which can be movable connected to the switching chamber 14. The first terminal 18 may be pushed onto the second terminal 20 by the actuator 12, thus bringing the switching chamber 14 or respective the circuit breaker 10 into a closed position, in which the contacts 22 of the circuit breaker are in electrical contact. Further, the terminal 18 may be moved away from the terminal 20 by the actuator 12, thus bringing the switching chamber 14 of the circuit breaker 10 into an opened position, in which the contacts 22 are electrically disconnected from each other.

In accordance with an exemplary embodiment, the actuator 12 can be an electromagnetic actuator that can be connected over an electrical line 24 with a voltage source 54. The actuator 12 has a switch circuit 26 that can be adapted to connect an electromagnetic coil 28 with the voltage source 54 and a controller 30 for controlling the switches of the switch circuit 26. For example, when the controller 30 receives a switch signal, the controller 30 can open and close the switches of the switch circuit 26, such that a magnetic field can be induced in the coil 28, which can cause the actuator 12 to move from a closed into an opened position as will be explained in the following.

FIG. 2 schematically shows a longitudinal cross-section through an actuator 12. The actuator 12 can have an armature 32 including a main armature disk 34, a shaft 36, and a small armature disk 38. The armature disks 34 and 38 can be parallel to each other and can be mechanically connected by the shaft 36, which can be used for guiding the armature 32 relative to the stator 40 of the actuator 12 in a linear movement between the positions when the two armature disks 34 and 38 touch the stator 40. The stator 40 can include an inner yoke 42, which can have a hole through which the shaft 36 can move as a part of the armature 32.

The stator 40 can include two permanent magnets 44 attached to side faces of the inner yoke 42 and two outer yokes 46 attached to the permanent magnets 44. The yokes 42, 46 and the permanent magnets 44 can form a comb-like structure with teeth defined by the end of the yokes pointing into the direction of the armature disk 34. Between the teeth there are two gaps in which a coil 48 can be situated, which can be wound around the inner yoke 42.

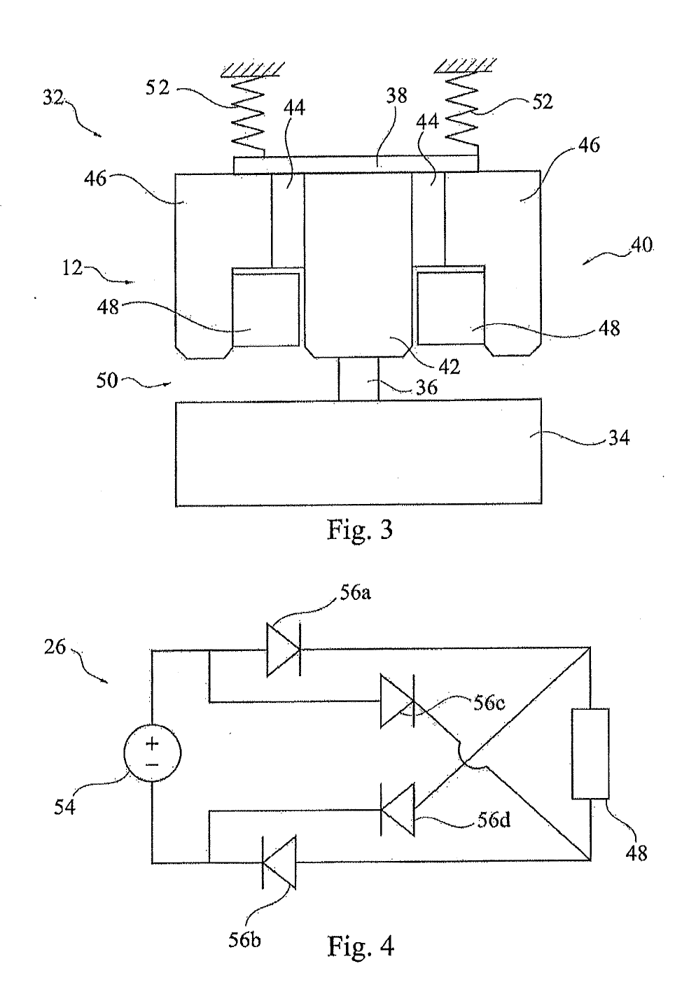

The actuator 12 shown in FIG. 2 is an actuator with two stable positions, for example, a closed position shown in FIG. 2 and an opened position shown in FIG. 3. In the closed position shown in FIG. 2, the stator 40 and the armature 32 form a magnetic circuit with a closed air gap 50 between the stator 40 and the armature components 42 and 46. The permanent magnets 44 can be placed in series into the magnetic circuit to provide a static magnetic flux that causes sufficiently strong magnetic forces holding the air gap 50 closed. A spring element 52 can be applied as a counterforce to the magnetic force generated by the permanent magnets 44. In the closed position shown in FIG. 2, the magnetic force generated by the permanent magnets 44 can be larger than the spring force generated by the spring element 52. Thus, the closed position can be stable, for example, even in the case of external mechanical excitations like earthquakes.

In accordance with an exemplary embodiment, the opening process of the actuator 12 can be started by excitation of the magnetic coil 48, such that the magnetic flux in the magnetic circuit can be reduced until the magnetic force is smaller than the spring force of the spring element 52. For example, once the total force on the armature 32 has a zero crossing, a net acceleration of the armature 32 will start the opening process. The more the gap between stator 40 and armature 32 has increased, the more the spring force will dominate the magnetic force. During the relaxation of the spring element 52, the spring force will decrease nearly linearly or stepwise linearly. For example, when the armature 32 approaches the open position, the spring force may be close to zero. A magnetic force caused by the magnetic flux of the permanent magnets 44 acting on the small disk 38 shall hold the armature 32 in a stable open position.

FIG. 3 shows schematically a longitudinal cross-section through the actuator 12 in the opened position. In the closed position, the stator 40 can abut the armature disk 34 with the side that houses the coil 48. In the open position, the stator 40 can abut the armature disk 38 with the opposite side. Thus, in the open position, the air gap 50 can be maximal.

The more the air gap 50 between the stator 40 and the disk 34 has increased, the more the spring force will dominate the magnetic force between stator and disk 34 until the spring force is supported by the attractive magnetic force between disk 38 and the stator 40. Due to this attractive force, the open position shown in FIG. 3 is also a stable position of the actuator 12. However as long as the magnetic flux of the coil 48 is reducing the magnetic force, the armature 32 can be getting faster when leaving the closed position. For example, as long as the coil 48 is connected to the power supply in such a (conventional) way, that it increasingly compensates the magnetic flux of the permanent magnet, the current in the coil 48 will rise, thus reducing the magnetic counterforce of the spring force, thus accelerating the armature 32 even more.

Once the armature 32 reaches its final opened position relative to the stator, shown in FIG. 3, it will have a certain kinetic energy, when the relative velocity is not zero. This kinetic energy can cause a mechanical bouncing due to the collision of the components of the actuator 12, which can cause the above-mentioned degrading of the switching properties of the circuit breaker.

In accordance with an exemplary embodiment, this bouncing effect can be reduced by supplying a reverse voltage to the coil 48 during the relative movement of the armature 32 and the stator 40. For example, once the armature 32 has reached a position relative to the stator 40, where the separation of the circuit breaker terminals 18, 20 has happened and after the kinetic energy of the armature 32 has exceeded the amount needed to reach the opened position, the polarity of the power supply may be reversed by the switch circuit 26 which can be controlled by the controller 30. Thus, the current in the coil 48 can be reduced with maximal change rate and the current in the coil 48 can change its polarity thus increasing the total magnetic force and hence decelerating the relative movement of armature 32 and stator 40.

FIG. 4 shows a diagram with a switch circuit 26 that is adapted to change the polarity of the voltage supplied to the coil 48. The switch circuit 26 can include four switches 56a, 56b, 56c, 56d that, for example, may be thyristors, and that are opened and closed by the controller 30. For connecting the coil 48 in a first direction to the DC voltage source 54, the controller 30 opens the switches 56a and 56b and closes the switches 56c and 56d. In accordance with an exemplary embodiment, a positive voltage can be supplied to the coil 48. For connecting the coil 48 in the other direction with the DC voltage source 54, the controller 30 can close the switches 56a, 56b and then open the switches 56c, 56d. For example, in such a way, a negative voltage can be supplied to the coil 48. For disconnecting the coil 48 from the voltage source 54, the controller 30 can open all the switches 56a, 56b, 56c, 56d.

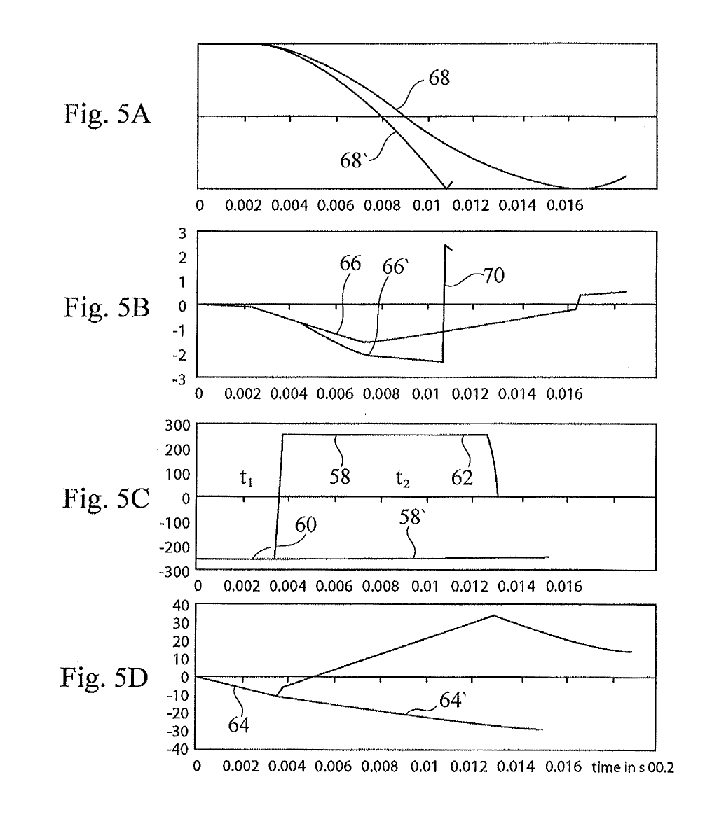

FIGS. 5A to 5D show diagrams which depict certain parameters of the switching operation of the actuator 12 over time. The lines 68, 66, 58, 64 in the diagrams show the parameters for the inventive solution. The lines 68′, 66′, 58′, 64′ show the parameters for a conventional actuator. In the diagrams, time is running from left to right and the values are given in seconds.

FIG. 5C shows the voltage signal 58 applied to the coil 48 and generated by the switch circuit 26 controlled by the controller 30. During a first time period t₁ of about 4 ms, a first constant voltage 60 is applied to the coil 48. As may be seen from FIG. 5D absolute value of the coil current 64 increases (see FIG. 5D), the absolute value of the velocity 66 between the armature 32 and the stator 40 increases (see FIG. 5B) and the relative position 68 between the armature 32 and the stator 40 decreases (see FIG. 5A).

After the first time period t₁, the voltage 58 supplied to the coil 48 is reversed for a second time period t₂, which lasts about 10 ms. As may be seen from FIG. 5C, a constant second voltage 62, which has the negative value of the first voltage 60 is applied to the coil 48. After the time period t₂, the voltage 58 is switched to 0.

The earlier the polarity of the DC voltage source 54 is reversed, the higher is the deceleration effect. However, if the time t₁ of the voltage reversal can be chosen too early, the armature 32 and the stator 40 will not reach their opened position and the opening operation may fail. If the voltage reversal t₁ is chosen too late, the influence on the bouncing behaviour may be very small. FIGS. 5A to 5D show, that a range of voltage reversal time can be determined, where a significant influence on the impact velocity at the armature 32 at the opened position can be achieved and thus the bouncing effect may be reduced.

For an optimal switching behaviour, for example, the movement of the armature 32 by a sensor can be assessed, for example a position-, velocity- or acceleration sensor. Then the time t1 can be adapted to the actual travel curve that may differ due to external influences like friction of temperature.

For example, due to the switching from the first voltage 60 to the second voltage 62, the absolute value of the coil current 64 starts to decrease. The coil current 64 changes its sign a short time after the voltage reversal t₁. Due to this, a reverse magnetic field can be induced in the coil 48, which starts to decelerate the movement of the stator 40 and the armature 32. As may be seen from FIG. 5B, after about 8 ms, the absolute value of the velocity 66 has reached its maximum value and decreases after that.

The time periods t₁ and t₂ are chosen in such a way, that the velocity 66 reaches nearly zero, when the relative position 68 reaches the opened position after about 16 ms. In such a way, nearly no bouncing of the components occurs compared to the situation in which the voltage is not changed to a reverse voltage.

This situation is shown with the lines 68′, 66′, 58′ and 64′ in FIG. 5A to 5D. If a constant voltage 58′ is applied to the coil 48, the absolute value of the coil current 64′ is increasing more and more and the absolute value of the velocity 66 is increasing until the armature 32 and the stator 40 impact on each other, which causes a back-bouncing 70.

While the disclosure has been illustrated and described in detail in the drawings and foregoing description, such illustration and description are to be considered illustrative or exemplary and not restrictive; the disclosure is not limited to the disclosed embodiments. Other variations to the disclosed embodiments can be understood and effected by those skilled in the art and practising the claimed disclosure, from a study of the drawings, the disclosure, and the appended claims.

In the claims, the word “including” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 circuit breaker
12 actuator
14 switching chamber
16 rod
18 first terminal
20 second terminal
22 electrical contact
24 electrical line
26 switch circuit
28 coil
30 controller
32 armature
34 main armature disk
36 shaft
38 small armature disk
40 stator
42 inner yoke
44 permanent magnet
46 outer yoke
48 coil
50 air gap
52 spring element
54 DC voltage source
56a-56d switch
58, 58′ voltage signal
60 first voltage
61, 61′ coil voltage signal
62 second voltage
63, 63′ coil current signal
64, 64′ coil current
65, 65′ observing apparatus
66, 66′ velocity
68, 68′ position
69, 69′ armature position signal
70 back bouncing
71 third voltage

What is claimed is:

1. A method for driving an actuator of a circuit breaker, the method comprising:
supplying a coil of the actuator with a first voltage, the coil configured to generate a magnetic field which causes an armature to move relative to a stator of the actuator from a closed position to an opened position; and
supplying the coil with a second voltage of reverse polarity with respect to the first voltage, while the armature is moving relative to the stator, and wherein the coil is configured to generate a reverse magnetic field, which decelerates the relative movement of the stator and the armature.

2. The method of claim 1, wherein the first voltage is almost constant during a first time period (t₁) and the second voltage is almost constant during a second time period (t₂).

3. The method of claim 1, comprising:
supplying the first voltage to the coil during a first time period (t₁);
supplying the second voltage to the coil for a second time period (t₂); and
switching off the second voltage after the second time period.

4. The method of claim 3, comprising:
choosing the first time period (t₁) and the second time period (t₂), such that a movement speed of the armature relative to the stator approaches a specified value, when the actuator is approaching the opened position.

5. The method of claim 3, comprising:
choosing the first time period (t₁) and the second time period (t₂) to minimize a time period, during which the armature is moving relative to the stator.

6. The method of claim 1, comprising:
supplying the first voltage to the coil during a first time period (t₁);
supplying the second voltage to the coil for a second time period (t₂);
supplying a third voltage with a same polarity as the first voltage for a third time period(t₃); and
switching off the third voltage after the third time period.

7. The method of claim 6, comprising:
choosing the first time period (t₁), the second time period (t₂), and third time period (t₃), such that a movement speed of the armature relative to the stator approaches a specified value, when the actuator is approaching the opened position.

8. The method of claim 6, comprising:
choosing the first time period (t₁), the second time period (t₂), and third time period (t₃) to minimize the time period, during which the armature is moving relative to the stator.

9. The method of claim 6, comprising:
choosing the first time period (t₁), the second time period (t₂), and third time period (t₃) for each operation by assessing a motion of the actuator.

10. The method of claim 9, comprising:
assessing the motion of the actuator using one or more sensors.

11. An actuator for a circuit breaker, the actuator comprising:
a stator and an armature, which are configured to be movable with respect to each other between a closed position and an opened position;
a coil configured to generate a magnetic field, which is adapted to cause a relative movement of the stator and the armature; and
a switch circuit configured to connect to a voltage source for supplying the coil with a voltage, and wherein the switch circuit is configured to supply a first voltage, a second voltage, and a third voltage to the coil, wherein the second voltage has a reverse polarity with respect to the first and the third voltages.

12. The actuator of claim 11, comprising:
a controller configured to control switches of the switch circuit, and wherein the controller is configured to control the supply of the first voltage, the second voltage and the third voltage to the coil.

13. The actuator of claim 11, comprising:
a magnet configured to generate a force acting on the main armature disk in a closing direction of the actuator while the actuator is in a closed position; and
a spring element configured to generate a force acting on the main armature disk in an opening direction opposite to the closing direction while the actuator is in the closed position.

14. The actuator of claim 13, wherein in the closed position, the force of the magnet is greater than the force of the spring element.

15. The actuator of claim 14, comprising:
a magnetic force caused by the magnet acting on the small armature disk, which is configured to hold the armature in an open position while the force of the spring element supports the magnetic force; and
wherein in the closed position, a sum of a magnetic force caused by the coil supplied with the first voltage and the force of the spring element is greater than the force of the magnet once a current in the coil has reached a specified value.

16. A circuit breaker, the circuit breaker comprising:
an actuator, the actuator which includes:
a stator and an armature, which are configured to be movable with respect to each other between a closed position and an opened position;
a coil configured to generate a magnetic field, which is configured to cause a relative movement of the stator and the armature; and
a switch circuit configured to connect to a voltage source for supplying the coil with a voltage, wherein the switch circuit is configured to supply a first voltage, a second voltage, and a third voltage to the coil, the second voltage having a reverse polarity with respect to the first and the third voltages; and
a switching chamber with a first terminal and a second terminal, wherein the actuator is mechanically connected to the first terminal of the switching chamber, such that the actuator is operable to move the first terminal between a closed position, in which the first terminal is electrically connected with the second terminal, and an opened position, in which the first terminal is electrically disconnected from the second terminal.

17. The circuit breaker of claim 16, comprising:
a controller configured to control switches of the switch circuit, and wherein the controller is configured to control the supply of the first voltage, the second voltage and the third voltage to the coil.

18. The circuit breaker of claim 16, comprising:
a magnet configured to generate a force acting on the main armature disk in a closing direction of the actuator while the actuator is in a closed position; and
a spring element configured to generate a force acting on the main armature disk in an opening direction opposite to the closing direction while the actuator is in the closed position.

19. The circuit breaker of claim 18, wherein in the closed position, the force of the magnet is greater than the force of the spring element.

20. The circuit breaker of claim 19, comprising:
a magnetic force caused by the magnet acting on the small armature disk, which is configured to hold the armature in an open position while the force of the spring element supports the magnetic force; and
wherein in the closed position, a sum of a magnetic force caused by the coil supplied with the first voltage and the force of the spring element is greater than the force of the magnet once a current in the coil has reached a specified value.
